(19) United States
(12) Patent Application Publication
(10) Pub. No.: US 2005/0248231 A1
(43) Pub. Date: Nov. 10, 2005

(54) Motor and information recording and reproducing apparatus

(75) Inventors: Shigeru Kojima, Saitama (JP); Akira Yasaki, Saitama (JP); Norio Matsuda, Saitama (JP); Hideki Kinoshita, Saitama (JP); Hitoshi Yamazaki, Saitama (JP); Jun Togashi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/087,643

(22) Filed: Mar. 24, 2005

(30) Foreign Application Priority Data
Mar. 24, 2004 (JP) P2004-087211

(51) Int. Cl. H02K 7/00; H02K 16/00

(52) U.S. Cl. 310/266; 310/112

(57) ABSTRACT

A motor includes: a stator provided with a plurality of coils, a rotor provided rotatably with respect to the stator, a first magnet which is mounted on the rotor and which faces one end of each of the plurality of coils, and a second magnet which is mounted on the rotor and which faces the other end of each of the plurality of coils.

The present disclosure relates to the subject matter contained in Japanese Patent Application No. 2004-087211 filed Mar. 24, 2004, which is incorporated herein by reference in its entirety.

### BACKGROUND OF THE INVENTION

1. Field of the Invention

The present invention relates to a motor and an information recording and reproducing apparatus.

2. Background Art

In recent years, an optical disk recording and reproducing apparatus for reproducing an optical disk such as a compact disk (CD) or a digital versatile disk (DVD) is widely used as one of information recording and reproducing apparatuses in various fields. The optical disk recording reproducing apparatus is configured such that various information are read from the optical disk and are recorded into the optical disk by irradiating laser light onto the optical disk and by receiving reflected light from while the optical disk mounted on and fixed to a turntable is rotated (for example, see JP-A-2003-58192 (FIG. 1)).

FIG. 1 is a cross-sectional view of a spindle motor 1 that rotates an optical disk together with a turntable, and FIG. 2 is a perspective view of a core member constituting the spindle motor 1.

The spindle motor 1 is a so-called outer rotor-type motor in which a cylindrical bearing 3 is vertically mounted on a flat panel-shaped base substrate 2 and a stator core 4 surrounds an outer surface of the bearing 3. As shown in FIGS. 1 and 2, the stator core 4 is provided with a plurality of cores 4b which are integrally formed and are radially protruded from a side surface of a circular base portion 4a in a top view toward an outer diameter direction. Copper lines are winded around the circumference of each core 4b to form windings 6, and the coil 7 is constituted by one core 4b and the windings 6.

A coupling rotor 8 is provided above the stator core 4. The coupling rotor 8 is a U-shaped member in a cross-sectional view in which a ring-shaped sidewall 8c is vertically mounted on a circumferential edge portion of a circular base portion 8b with an opening 8a at its center. A rotational axis 5 is mounted on the opening 8a via an axis fixing member 9. The rotational axis 5 is mounted rotatably with respect to the bearing member 3a of the bearing 3 provided in the base substrate 2 to substantially completely cover the stator core 4. An upper surface 8d of the coupling rotor 8 is used for mounting the optical disk, and the optical disk is inserted into a mounting portion (not shown) provided on the upper surface 8d to align with the opening diameter of the optical disk. Then, the optical disk is mounted on the upper surface 8a of the coupling rotor 8. That is, the coupling rotor 8 constitutes the turntable of the optical disk recording and reproducing apparatus.

In addition, a rotor magnet 9 is fixed to face the axial direction of the coil 7 on the inner circumferential surface of the ring-shaped sidewall 8c of the coupling rotor 8. By means of the magnetic interaction between the coil 7 and the rotor magnet 9, the coupling rotor 8 rotates around the rotational axis 5, which allows the optical disk mounted on the upper surface of the coupling rotor 8 to be rotated.

### SUMMARY OF THE INVENTION

In the optical disk recording and reproducing apparatus, an increase in rotation speed of the optical disk has been contrived to increase the recording speed. To safely rotate the spindle motor at a high speed, it is necessary to enhance the rotation torque of the motor. However, in the case of increasing the number of the windings constituting the coil so as to enhance the rotation torque, the total thickness of the coil becomes thick, which results in increasing the thickness of the spindle motor. As a result, the spindle motor becomes large, which is not suitable for a thin optical disk recording and reproducing apparatus. In addition, a method which increases the amount of current flowing into the coil of the spindle motor so as to enhance the rotation torque has been considered. However, the motor torque is generally saturated in any region with respect to the current value, such that the motor torque is not enhanced even when current more than a certain level flows. Further, the amount of power consumption and the amount of heat are increased in the coils. As such, it is difficult to efficiently increase the torque of the motor when the size of the motor is not changed.

It is an object of the invention to efficiently increase a torque of a motor even when the size of the motor is not changed.

The invention provides a motor including: a stator provided with a plurality of coils; a rotor provided rotatably with respect to the stator; a first magnet which is mounted on the rotor and which faces one end of each of the plurality of coils; and a second magnet which is mounted on the rotor and which faces the other end of each of the plurality of coils.

The invention provides a motor including: a rotor provided with a plurality of ring-shaped magnets having different diameters from one another; and a stator having a plurality of coils each being disposed between the plurality of ring-shaped magnets.

The invention provides an optical disk recording and reproducing apparatus including a motor, wherein the motor includes: a stator provided with a plurality of coils; a rotor provided rotatably with respect to the stator; a first magnet which is mounted on the rotor and which faces one end of each of the plurality of coils; and a second magnet which is mounted on the rotor and which faces the other end of each of the plurality of coils.

The invention provides an information recording and reproducing apparatus including a motor, wherein the motor includes: a stator provided with a plurality of coils; a rotor provided rotatably with respect to the stator; a first magnet which is mounted on the rotor and which faces one end of each of the plurality of coils; and a second magnet which is mounted on the rotor and which faces the other end of each of the plurality of coils.

The invention provides an electric generator including: a rotor provided with a plurality of ring-shaped magnets having different diameters from one another; and a stator having a plurality of coils each being disposed between the plurality of ring-shaped magnets.

### BRIEF DESCRIPTION OF THE DRAWINGS

The present invention may be more readily described with reference to the accompanying drawings:

FIG. 1 is a cross-sectional view of a spindle motor according to a related art.

FIG. 2 is a perspective view of a core member constituting the spindle motor according to the related art.

FIG. 3 is a diagram showing relationship between a line of magnetic force and a magnet.

FIG. 4 is a plan view showing essential parts of a reading and reproducing device of an optical disk recording and reproducing apparatus according to the invention.

FIG. 5 is an exploded perspective view of the spindle motor according to the invention.

FIG. 6 is a traverse cross-sectional view of the spindle motor according to the invention.

FIG. 7 is a longitudinal cross-sectional view of the spindle motor according to the invention.

FIG. 8 is a plan view of a stator core according to the invention.

FIG. 9 is a diagram showing relationship between a line of magnetic force and a magnet according to the invention.

FIG. 10 is a diagram showing a modification of the spindle motor according to the invention.

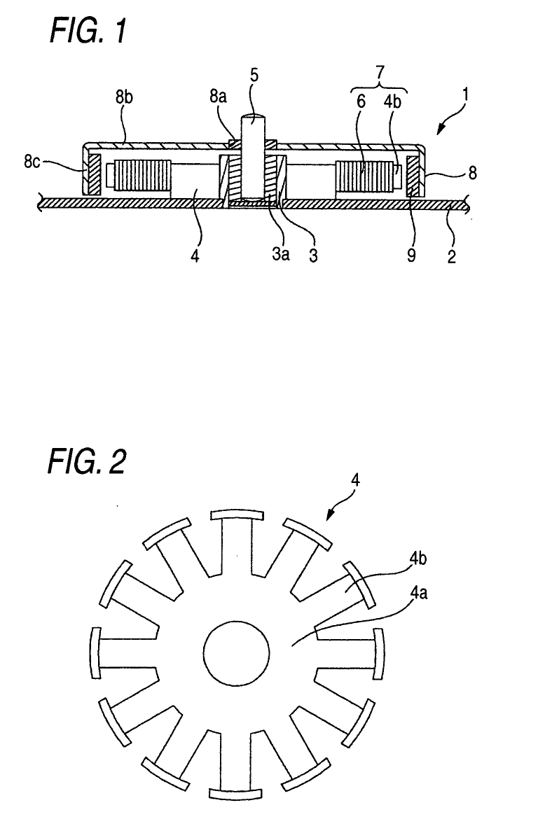

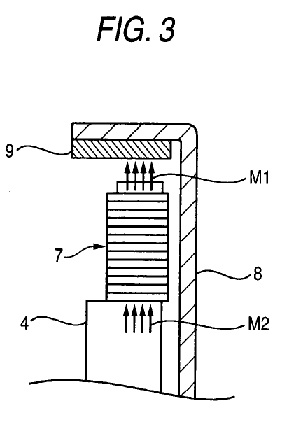

### DETAILED DESCRIPTION OF THE PREFERRED EMBODIMENTS

Hereinafter, an embodiment of a motor and an information recording and reproducing apparatus according to the invention will be described with reference to the accompanying drawings. In the description, an optical disk recording and reproducing apparatus is exemplified as the information recording and reproducing apparatus. Further, a spindle motor for rotating a disk, which is provided in the optical disk recording and reproducing apparatus, is exemplified.

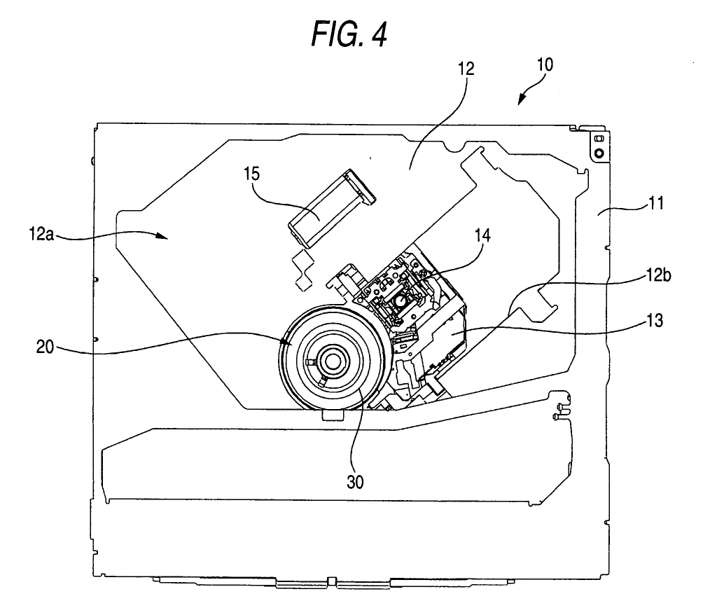

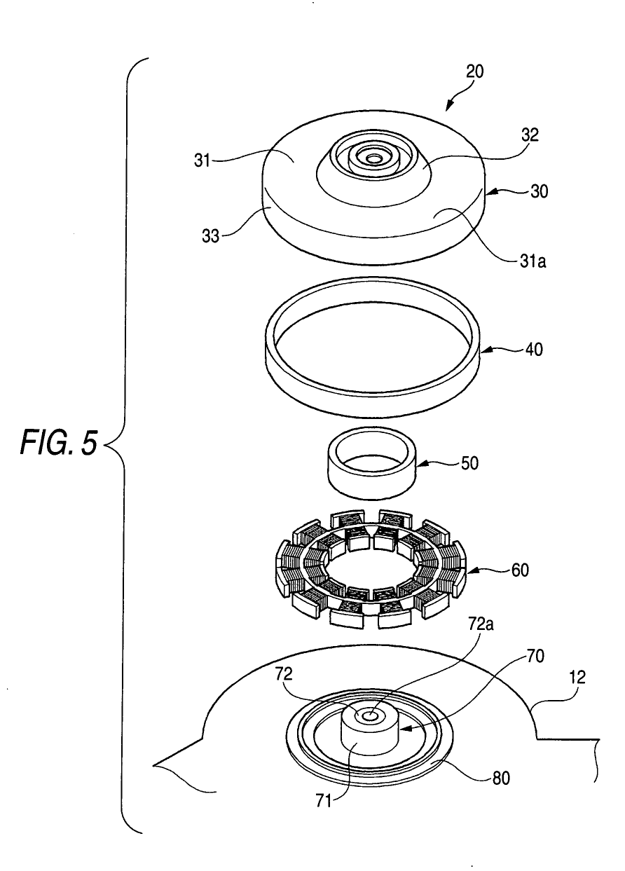

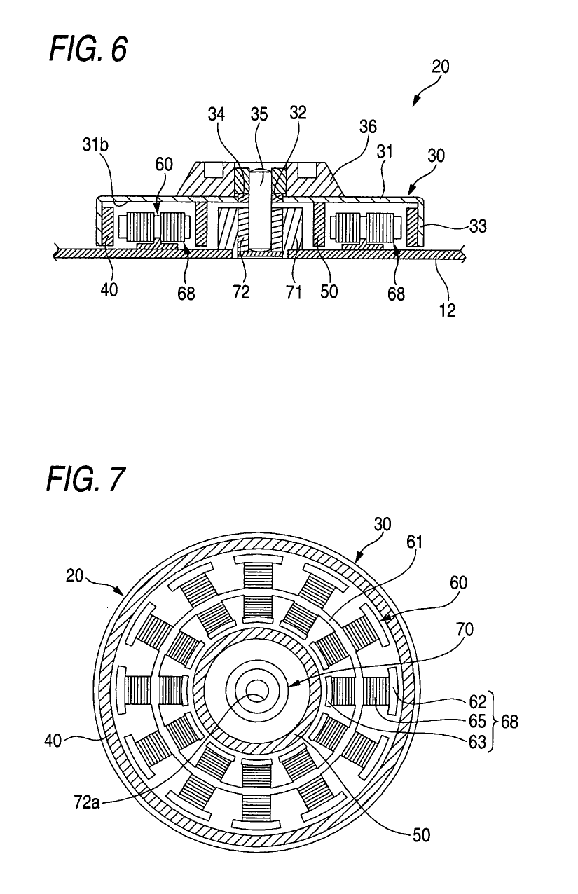

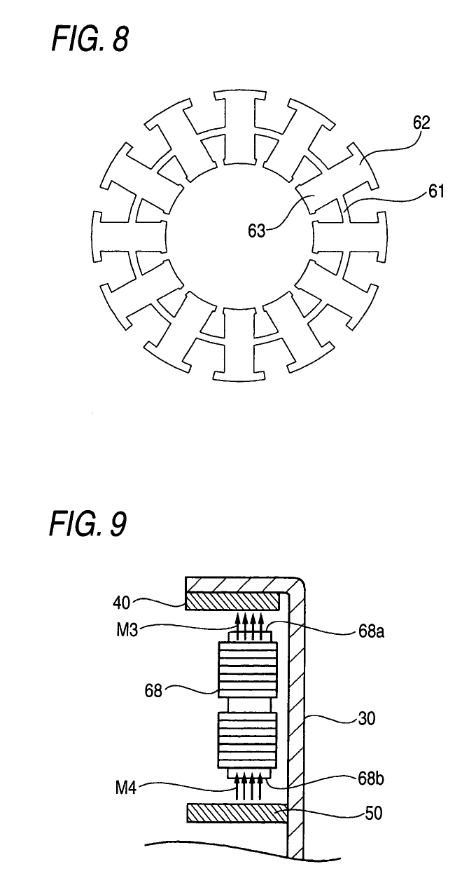

FIG. 4 is a plan view showing essential parts of a reading and reproducing device of the optical disk recording and reproducing apparatus of the present embodiment. FIG. 5 is an exploded perspective view of a spindle motor. FIG. 6 is a traverse cross-sectional view of the spindle motor. FIG. 7 is a longitudinal cross-sectional view of the spindle motor. FIG. 8 is a plan view of a stator core.

The optical disk recording and reproducing apparatus 10 of the present embodiment includes a first chassis 11, a second chassis 12, a carriage 13, an objective lens 14, a motor 15, and a turntable 30, as shown in FIG. 4.

The first chassis 11 and the second chassis 12 are substantially rectangular base substrates in a top view, for example, molded by a punching press process. The first chassis 11 and the second chassis 12 are connected to each other via a hinge mechanism (not shown) and are configured to allow the optical disk to be inserted therebetween.

The spindle motor 20 having the turntable 30 for rotating the optical disk D is mounted on a surface 12a of the second chassis 12. The optical disk D is mounted on the turntable 30 and rotates according to the rotation of the spindle motor 20 while being held on the turntable 30 by a chuck (not shown).

On the other hand, the carriage 14 is mounted on a back surface of the second chassis 12. In the carriage 14, an optical pickup device having a laser light source (not shown), an objective lens 14, and the like is provided. Laser light emitted from the laser light source is outputted from the objective lens 14 formed substantially at a central portion of the carriage 13 and is irradiated toward an information recording surface of the optical disk via an opening 12b provided in the second chassis 12. The optical disk recording and reproducing apparatus 10 reads the information from the optical disk or records the information into the optical disk with laser light.

The motor 15 is a driving source for allowing the carriage 13 to slide along a diameter direction of the optical disk. The objective lens 14 slides along the diameter direction of the optical disk according to the slide of the carriage 13. As a result, laser light may be irradiated over the entire region of the optical disk from the objective lens 14.

Next, the spindle motor 20 of the present embodiment will be described.

As shown in FIGS. 5 and 6, the spindle motor 20 includes the turntable 30, a first magnet 40, a second magnet 50, a stator 60, and a bearing 70.

The turntable 30 is a U-shaped member in a cross-sectional view in which a ring-shaped sidewall 33 is vertically disposed at a circumferential edge portion of a circular base portion 31 with an opening 32 at its center, and serves as a rotor for the stepping motor 20. A rotational axis 35 is mounted on the opening 32 formed in the base portion 31 via an axis fixing member 34. An upper surface 31a of the base portion 31 is used for mounting the optical disk. The optical disk is inserted into a mounting member 36 fixed to the upper surface 31a to align with an opening diameter of the optical disk, such that the optical disk is mounted on the upper surface 31a.

The ring-shaped first magnet 40 is fixed to the inner circumferential surface of the ring-shaped sidewall 33 of the turntable 30 by means of an adhesive or the like. In addition, the second magnet 50 is fixed to a lower surface 31b of the base substrate 31 of the turntable 30 at a predetermined interval from the first magnet 40. The outer diameter of the second magnet 50 is shorter than the inner diameter of the first magnet 40 and the second magnet 50 is coaxially mounted with respect to the first magnet 40 around the central axis 35, such that the second magnet 50 is positioned at an inner diameter side of the first magnet 40.

The cylindrical bearing 70 is vertically disposed on the second chassis 12. The bearing 70 has a cylindrical bearing holding member 71, and a cylindrical bearing member 72 which is inserted into the inner surface of the bearing holding member 71. The rotational axis 35 of the turntable 30 is inserted into an insertion hole 72a of the bearing member 72 and is rotatably held with the inner surface of the bearing member 72 as a supporting surface.

In addition, a ring-shaped stator fixing unit 80 is provided in the second chassis 12 and the stator 60 is fixed to the stator fixing unit 80.

As shown in FIG. 7, the stator 60 has a stator core base portion 61 and windings 65. The stator core base portion 61 is a ring-shaped member a lower surface of which is fixed to the stator fixing unit 80. Plural pairs of core convex portions 62 and 63 in an outer diameter direction and an inner diameter direction of the stator core base portion 61 are disposed at a constant interval around the ring-shaped stator core base portion 61. That is, the core convex portions 62 and 63 are integrally protruded at the inner and outer diameter sides radially from the ring center of the stator core base portion 61. The windings 65 are wound substantially on each of convex cores 62 and 63 in a direction perpendicular to the diameter direction. The coil 68 is constituted by the pair of the concave cores 62 and 63 and the windings 65 wound around each of the concave cores 62 and 63.

In addition, the rotational axis 35 of the turntable 30 is axially and rotatably supported by the insertion hole 72a of the bearing member 72 so as to allow the turntable 30 to substantially completely cover the stator 60. Further, in the state in which the turntable 30 is mounted on the bearing member 72, the magnet 40 is disposed at a predetermined interval from the coil 68 at the outer diameter side of the coil 68 and the magnet 50 is disposed at a predetermined interval from the coil 68 at the inner diameter side of the coil 68. Magnetization patterns having the same number as that of the coils 68 are formed on the inner circumferential surface and the outer circumferential surface of each of the magnet 40 and 50 by alternately changing the directions of N pole and S pole with adjacent magnetization patterns.

When current flows into the coil 68, as shown in FIG. 9, a rotational torque of the motor is generated by means of a magnetic interaction between the first magnet 40 mounted on the turntable 30 and lines of magnetic force M3 outputted from an outer diameter-side end surface 68a of the coil 68 (or inputted to the end surface 68a). Further, a rotational torque of the motor is generated by means of a magnetic interaction between the second magnet 50 mounted on the turntable 30 and lines of magnetic force M4 inputted to an inner diameter-side end surface 68b of the coil 68 (or outputted from the end surface 68b). That is, according to the spindle motor 20 of the present embodiment, the outer diameter-side end surface 68a and the inner diameter-side end surface 68b of the coil 68 interact with the opposite first magnet 40 and the second magnet 50, respectively, without wasting the lines of magnetic force, such that the rotational torque of the motor can be enhanced.

Further, in the spindle motor 20, when the outer diameter-side end surface 68a and the inner diameter-side end surface 68b of the coil 68 interact with the first magnet 40 and the second magnet 50, respectively, the condition for increasing the efficiency of the rotational torque of the motor is given by the following expression (1), as compared to the case in which the rotational torque of the motor is generated by the interaction between the outer diameter-side end surface 68a of the coil 68 and the first magnet 50 without providing the second magnet 50.

$$\frac{1}{D} ( 1 + \frac{{r}_{4} {r}_{5}}{{r}_{2} {r}_{3}} ) > 1 \\ D = 1 + \frac{{r}_{5}^{4} - {r}_{6}^{4}}{{r}_{1}^{4} - {r}_{2}^{4}} \qquad ( 1 )$$

G: Enhancement rate of the torque as compared to the motor according to the related art with no magnet at the inner diameter side

r₁: Outer radius of the first magnet 40

r₂: Inner radius of the first magnet 40

r₃: Outer radius of the stator core 60 (core convex portion 62)

r₄: Inner radius of the stator core 60 (core convex portion 63)

r₅: Outer radius of the second magnet 50

r₆: Inner radius of the second magnet 50

That is, according to the present embodiment, the first magnet 40 and the second magnet 50 are disposed with respect to the coil 68 to satisfy the expression (1), such that the rotational torque of the motor can be enhanced as compared to the motor according to the related art.

As described above, the spindle motor 20 of the present embodiment includes the stator 60 provided with a plurality of coils 68, the turntable 30 provided rotatably with respect to the stator 60, the first magnet 40 which is mounted on the turntable 30 and which faces the end surface 68a of each of the plurality of coils 68, and the second magnet 50 which is mounted on the turntable 30 and which faces the end surface 68b of each of the plurality of coils 68. Specifically, the plurality of coils 68 provided in the stator 60 are disposed at a constant interval around the stator 60. Further, the first magnet 40 is the ring-shaped member which faces each of the plurality of coils 68 at the outer diameter side of the stator 60. The second magnet 50 is the ring-shaped member which faces each of the plurality of coils 68 at the inner diameter side of the stator 60.

According to the spindle motor 20 of the present embodiment, the outer diameter-side end surface 68a of each of the plurality of coils 68 interacts with the first magnet 40 to generate the rotational torque of the motor and the inner diameter-side end surface 68b of each of the plurality of coils 68 interacts with the second magnet 50 to generate the rotational torque of the motor. That is, according to the spindle motor 20 of the present embodiment, the second magnet 50 is provided at the inner diameter side of the coil 68. As a result, the rotational torque of the motor can be generated by effectively using both of the lines of magnetic force of the outer diameter side of the coil 68 and the lines of magnetic force of the inner diameter side of the coil 68.

As a result, it is possible to enhance the rotational torque of the motor with a simple configuration without increasing the amount of current flowing into the coil 68 as compared to the motor according to the related art with no magnet at the inner diameter side. In addition, when the magnet 50 is disposed, the thickness of the spindle motor 20 in the diameter direction is hardly changed, so that the size of the spindle motor 20 can substantially remain the same as that of the motor according to the related art. Accordingly, it is possible to provide an optical disk recording and reproducing apparatus which has superior rotation characteristics without sacrificing the size by using the spindle motor with high torque.

Moreover, in the present embodiment, the configuration in which the motor is provided with the plurality of coils disposed in a ring shape on the same circumference and the magnets are disposed at the inner and outer diameter sides of the motor. However, the invention is not limited to this configuration.

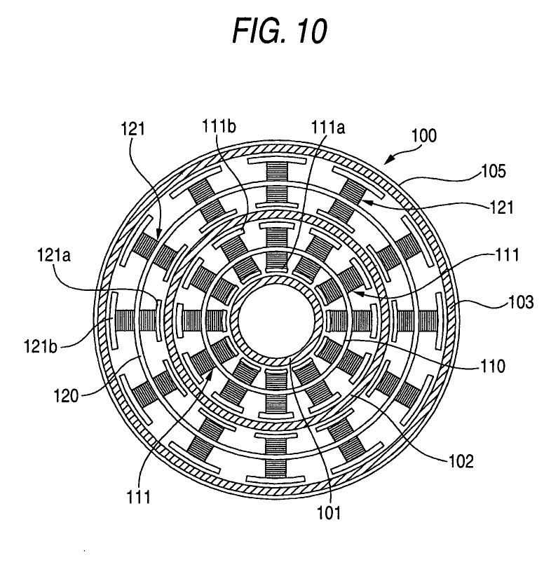

For example, FIG. 10 is a traverse cross-sectional view showing a modification of the spindle motor 20 of the embodiment.

Ring-shaped magnets 101, 102, and 103 having different diameters from one another are coaxially mounted on a rotor 105 of a spindle motor 100 shown in FIG. 10. A first stator 110 in which a plurality of coils 111 are disposed at a constant interval on the same circumference is arranged between the magnet 101 and the magnet 102. A second stator 120 in which a plurality of coils 121 are disposed at a constant interval on the same circumference is arranged between the magnet 102 and the magnet 103.

In the case of the spindle motor 100, a magnetic interaction is generated between an inner diameter-side end surface 111a of each coil of the first stator 110 and an outer diameter-side end surface of the magnet 101 to produce the torque of the motor. Further, a magnetic interaction is generated between an outer diameter-side end surface 111b and an inner diameter-side end surface of the magnet 102 to produce the torque of the motor. In addition, a magnetic interaction is generated between an inner diameter-side end surface 121a of each coil of the second stator 120 and an outer diameter-side end surface of the magnet 102 to produce the torque of the motor. Further, a magnetic interaction is generated between an outer diameter-side end surface 121b and an inner diameter-side end surface of the magnet 103 to produce the torque of the motor.

As such, the rotor 105 provided with the plurality of ring-shaped magnets 101, 102, 103 having different diameters from one another, and the first stator 110 and the second stator 120 having a plurality of coils 111 and 121 each coil being interposed between the plurality of ring-shaped magnets 101, 102, and 103 are provided in the spindle motor 100. As a result, the lines of magnetic force outputted from the end surface of each coil can be effectively used, thereby generating the rotational torque of the motor.

Moreover, in the description, the optical disk recording and reproducing apparatus has been described as an example of the information recording and reproducing apparatus. However, the invention is not limited thereto. The invention may be applied to various recording and reproducing apparatuses which perform recording or reproduction on a recording medium using the spindle motor.

Moreover, in the description, the present embodiment has been described by way of the motor for converting an electric force to a rotational force. However, the invention is not limited thereto. For example, the above-described configuration may be applied to an electric generator which rotates the rotor by means of external force to derive an electromotive force generated by each coil. When the above-described configuration is applied to the generator, it is expected that the efficiency of generating the electric force increases according to the configuration of the present embodiment. Therefore, it is possible to properly apply the configuration to the generator.

### EXAMPLE

As regards the spindle motor 20 shown in FIG. 6, on an assumption of the following design values, the torque is calculated. Further, the enhancement rate G of the torque was also calculated as compared to the motor according to the related art with no magnet at the inner diameter side (equation 1).

Outer radius of the first magnet 40 r₁: 14 mm

Inner radius of the first magnet 40 r₂: 13 mm

Outer radius of the stator core 60 (core convex portion 62) r₃: 12.5 mm

Inner radius of the stator core 60 (core convex portion 63) r₄: 6.25 mm

Outer radius of the second magnet 50 r₅: 5.75 mm

Inner radius of the second magnet 50 r₆: 4.75 mm

When the equation 1 is substituted with these values, G becomes 1.15. That is, when the magnets are mounted on the inner and outer diameter sides, it was confirmed that the torque increases by about 15% as compared to the motor according to the related art with no magnet at the inner diameter side.

1. A motor comprising:
a stator provided with a plurality of coils;
a rotor provided rotatably with respect to the stator;
a first magnet which is mounted on the rotor and which faces one end of each of the plurality of coils; and
a second magnet which is mounted on the rotor and which faces the other end of each of the plurality of coils.

2. The motor according to claim 1,
wherein the plurality of coils provided in the stator are disposed at a constant interval around the stator;
the first magnet is a ring-shaped member which faces the plurality of coils at an outer diameter side of the stator; and
the second magnet is a ring-shaped member which faces the plurality of coils at an inner diameter side of the stator.

3. The motor according to claim 1,
wherein the first and second magnets are disposed with respect to the plurality of coils to satisfy the following relationship:
$$\frac{1}{D} ( 1 + \frac{{r}_{4} {r}_{5}}{{r}_{2} {r}_{3}} ) > 1$$
$$D = 1 + \frac{{r}_{5}^{4} - {r}_{6}^{4}}{{r}_{1}^{4} - {r}_{2}^{4}}$$
r₁: Outer radius of the first magnet
r₂: Inner radius of the first magnet
r₃: Outer radius of a stator core (core convex portion 62)
r₄: Inner radius of the stator core (core convex portion 63)
r₅: Outer radius of the second magnet
r₆: Inner radius of the second magnet

4. A motor comprising:
a rotor provided with a plurality of ring-shaped magnets having different diameters from one another; and
a stator having a plurality of coils each being disposed between the plurality of ring-shaped magnets.

5. An optical disk recording and reproducing apparatus comprising a motor,
wherein the motor includes:
a stator provided with a plurality of coils;
a rotor provided rotatably with respect to the stator;
a first magnet which is mounted on the rotor and which faces one end of each of the plurality of coils; and
a second magnet which is mounted on the rotor and which faces the other end of each of the plurality of coils.

6. An information recording and reproducing apparatus comprising a motor,
wherein the motor includes:
a stator provided with a plurality of coils;
a rotor provided rotatably with respect to the stator;
a first magnet which is mounted on the rotor and which faces one end of each of the plurality of coils; and
a second magnet which is mounted on the rotor and which faces the other end of each of the plurality of coils.

7. An electric generator comprising:
a rotor provided with a plurality of ring-shaped magnets having different diameters from one another; and
a stator having a plurality of coils each being disposed between the plurality of ring-shaped magnets.
